(19) United States
(12) Patent Application Publication
(10) Pub. No.: US 2026/0194379 A1
(43) Pub. Date: Jul. 9, 2026

(54) METHOD FOR PRODUCING A PROBE ELEMENT, AND PROBE ELEMENT

(71) Applicant: Endress+Hauser Flowtec AG, Reinach (CH)

(72) Inventor: Stephan Gaberthüel, Oberwil (CH)

(21) Appl. No.: 19/133,342

(22) PCT Filed: Nov. 16, 2023
(86) PCT No.: PCT/EP2023/082004

§ 371 Date: May 28, 2025

(30) Foreign Application Priority Data
Dec. 1, 2022 (DE) 10 2022 131 883.4

(51) Int. Cl. G01F 1/68; G01K 13/02

(52) U.S. Cl. CPC G01F 1/68; G01K 13/02

(57) ABSTRACT

A process for producing a probe element includes providing an elongate probe body having a longitudinal axis, wherein the probe body is produced by a generative, in particular additive, manufacturing process, using a 3D printing process using at least two different materials, wherein the probe body includes an exterior probe sleeve and an interior probe core located in the probe sleeve, and wherein the probe core and the probe sleeve are integrally connected to one another in the generative manufacturing process. A thermal flowmeter includes such a probe element.

The invention relates to a process for producing a probe element, to such a probe element, and to a thermal flowmeter having such a probe element.

A thermal flowmeter typically comprises probe elements which extend into a measuring tube of such flowmeters and around which a medium, in particular a fluid, flows during operation. Typically, at least one probe element is configured to sense a temperature of the medium (temperature-sensing probe element) and at least one probe element is configured to heat the medium (heating probe element). For example, a mass flow rate can be inferred from a heating current which is required to maintain a temperature difference between the heating probe element and the temperature-sensing probe element.

In order to be able to quickly sense a temperature change of the medium or a flow rate change, a low thermal mass of the probe element and a good thermal transition between the probe element and the medium are important.

DE 10 2016 121 110 A1 proposes producing a probe element by melting silver as a probe core in a probe sleeve. In principle, a good thermal transition between the probe element and the medium can be produced in this way, but the process is susceptible to the formation of bubbles, making the formation of cavities difficult to control. This results in a high proportion of rejects in the manufacturing of the probe elements.

To solve this problem, DE 10 2019 110 312 A1 proposes providing a rod for a probe element. A separate probe sleeve and a probe core are provided. By means of explosion welding, the probe sleeve is deformed radially towards the probe core entirely, with respect to the longitudinal axis, and this creates an integral connection between the probe sleeve and the probe core and thus the rod is manufactured. This solution reduces the formation of cavities in comparison with DE 10 2016 121 110 A1. However, one disadvantage of explosion welding is that the shape of the probe body is limited to extruded profiles. In addition, a rounded probe head is then mounted to the rod, so the probe core is only subsequently closed off by a plug.

The object of the invention is therefore to provide an improved process for producing a probe element and to provide an improved probe element.

The object is achieved by a process for producing a probe element and by a probe element.

Regarding the process for producing a probe element, the object is achieved by:
a process for producing a probe element that can be inserted into a medium, in particular a probe element for a temperature sensor for measuring the temperature of the medium or a probe element for a thermal flowmeter for measuring the mass flow rate of the medium in a measuring tube, the process comprising the steps of:
   providing an elongate probe body having a longitudinal axis,
wherein the probe body is produced by a generative, in particular additive, manufacturing process, by means of a 3D printing process using at least two different materials,
wherein the probe body has an exterior probe sleeve and an interior probe core located in the probe sleeve,
wherein in particular the probe sleeve at least partially spatially surrounds the probe core,
and wherein the probe core and the probe sleeve are integrally connected to one another in the generative manufacturing process.

In particular, within the scope of the invention, the probe body is thus produced in a primary forming process by generative manufacturing (classified in group 1.10 according to DIN 8580 of the primary forming manufacturing processes).

In the generative manufacturing process (also 3D printing process; all known generative production processes are to be subsumed under the term “3D printing process”), the integral connection between the interior probe core and the exterior probe sleeve is advantageously established directly. This results in an improved thermal transition between the probe core and the probe sleeve. Furthermore, there are substantially no restrictions on the shape of the elongate probe body in the generative manufacturing process.

In particular, the probe core and the probe sleeve are manufactured in a joint printing procedure in the generative manufacturing process.

In one embodiment of the process, the probe body is manufactured, in particular in the generative manufacturing process, such that the probe body has a closure which is to face the medium, at which closure the probe body is closed media-tight.

Thus, in particular, the closure is already part of the probe body manufactured in the generative manufacturing process and is manufactured directly as media-tight. An additional probe head or plug for closing the probe body on the media side is not required. The media-tight closure is provided in particular by the exterior probe sleeve, i.e., it is formed directly by the probe sleeve. The shape of the closure is optimized, e.g., flow-optimized. In particular, the closure has a rounded shape.

In one embodiment of the process, the process comprises the step of:
mechanically processing, in particular machining, a surface of the probe element, in particular of the probe sleeve, such that the surface has an average roughness (Ra) of less than 3.2 μm (micrometers), in particular less than 0.8 μm (micrometers), after the probe body has been provided by the generative manufacturing process.

In particular, the average roughness for a probe body according to the invention is less than 0.3 μm (micrometers).

In particular, the machined face is the surface of the probe body, in particular of the probe sleeve, that can be brought into contact with the medium.

In particular, the probe body is machined entirely. In the case of a substantially cylindrical probe body, the probe body is machined, for example, by turning. This preferably occurs on the entire cylindrical lateral surface.

In one embodiment of the process, the process comprises the steps of:
mechanically processing, in particular machining, a connection face in a connection region of the probe body, which connection region is in particular opposite from the closure, with respect to the longitudinal axis of the probe body;
placing at least one sensor element on the connection face such that the at least one sensor element is thermally coupled to the probe core;
fitting a connection sleeve onto the probe body on the side of the connection face such that the at least one sensor element is covered by the connection sleeve.

Preferably, the sensor element is thermally coupled to the probe core in that the interior probe core is or becomes exposed at the connection face, in particular at least in parts, and the probe element placed on the connection face is attached to that region of the connection face in which the probe core is exposed. This results in direct contact between the probe core and the sensor element, so that the thermal coupling of the sensor element to the probe core is established. The exposing of the probe core at the connection face occurs, for example, after the step of providing the probe body, namely only when the machining is carried out. Alternatively, within the scope of the invention it is also possible to design the probe core, which is exposed at the connection face at least in parts, as exposed directly during the production of the probe body in the generative printing process.

The average roughness at the connection face is, in particular, less than 3.2 μm (micrometers).

The connection face optionally has an angle to the longitudinal axis; see, for example, the exemplary embodiments explained below.

In one embodiment of the process, the at least one sensor element is mechanically connected to the machined connection face, the at least one sensor element being soldered, glued and/or sintered onto the connection face.

Preferably, the sensor element is sintered onto the machined connection face.

In one embodiment of the process, after the connection sleeve is fitted onto the probe body, a media-tight connection is established between the connection sleeve and the probe body.

This is achieved in particular by welding the connection sleeve to the probe body.

In one embodiment of the process, the probe sleeve is made of a first material, the probe core is made of a second material, and the first material has a lower thermal conductivity than the second material.

In one embodiment of the process, the probe core and the probe sleeve are built up layer by layer during the generative manufacturing process, and layers with a layer thickness of 10-500 μm (micrometers) are formed during the generative manufacturing process.

In one embodiment of the process, the generative manufacturing process is an additive manufacturing process in which one of the following additive manufacturing processes is used: selective laser melting, electron beam melting, selective laser sintering.

Regarding the probe element, the object is achieved by:

A probe element, in particular for a temperature sensor for measuring the temperature of the medium or for a thermal flowmeter for measuring the mass flow rate of the medium in a measuring tube, in particular obtainable by a process according to the invention, the probe element comprising:
an elongate probe body produced by a generative manufacturing process using at least two different materials and having a longitudinal axis, the probe body comprising an exterior probe sleeve and an interior probe core located in the probe sleeve,
wherein in particular the probe sleeve at least partially spatially surrounds the probe core,
and wherein the probe core and the probe sleeve are integrally connected to one another, in particular by means of the generative manufacturing process.

In one embodiment of the probe element, the probe element comprises:
at least one sensor element, which is placed on a connection face in a connection region of the probe body, which connection region is in particular opposite from the closure, with respect to the longitudinal axis of the probe body, the at least one sensor element being thermally coupled to the probe core; and
a connection sleeve which is fitted onto the probe body on the side of the connection face such that the connection sleeve covers the at least one sensor element, the connection sleeve and the probe body being connected to one another media-tight.

In one embodiment of the probe element, the at least one sensor element is one of the following:
a temperature sensor element;
a heating element;
a sensor element designed both for measuring the temperature and for heating.

For example, the sensor element is a resistance-based sensor element, e.g., a cold-conducting resistance element, in particular a Pt100. In the last case, the sensor element is designed as a combined heating/temperature-measuring element which is designed both for measuring the temperature and for heating, depending on operation.

In one embodiment of the probe element, the probe sleeve has a first material and the probe core has a second material, and the first material has a lower thermal conductivity than the second material.

In one embodiment of the probe element, the second material has a thermal conductivity of at least 100 W/(m*K), in particular at least 300 W/(m*K). In one embodiment of the probe element, the first material is stainless steel and/or nickel steel, and/or the second material is selected from one of the following: silver, copper, or an alloy comprising silver and/or copper, in particular comprising silver and/or copper in a proportion of at least 60 percent by weight.

In one embodiment of the probe element, the probe body has a substantially cylindrical shape, in which the probe body has a round or elliptical cross-sectional area perpendicularly to the longitudinal axis.

In one embodiment of the probe element, the probe body has a streamlined and/or angular cross-sectional area perpendicularly to the longitudinal axis.

In one embodiment of the probe element, the probe body has, perpendicularly to the longitudinal axis, a cross-sectional area which changes along the longitudinal axis and in particular tapers from the connection region towards the closure of the probe body.

In one embodiment of the probe element, the probe core has a minimum diameter of at least 1.5 mm and/or the probe sleeve has a maximum diameter of at most 5 mm.

In one embodiment of the probe element, the probe sleeve forms a wall for the probe body, with a wall thickness of less than 0.5 mm, in particular less than 0.1 mm.

In one embodiment of the probe element, in each cross-sectional area of the probe body perpendicular to the longitudinal axis, the probe core constitutes at least 80%, in particular at least 90%, of the cross-sectional area, in a probe core portion, which probe core portion extends, in the direction of the longitudinal axis, from the connection face to the end of the probe core adjacent to the closure.

The invention also relates to a thermal flowmeter comprising:
a measuring tube for guiding a flowable medium;
at least one probe element according to the invention, the probe element being located in the measuring tube;
an electronic measuring/operating circuit for operating the at least one probe element and for providing flow measurement values; and
a housing for housing the electronic measuring/operating circuit.

In one embodiment of the thermal flowmeter, the thermal flowmeter comprises:
a first probe element having at least one sensor element designed for heating;
and a second probe element having at least one sensor element designed for measuring the temperature;
wherein the electronic measuring/operating circuit is configured to heat the first probe element and to determine the temperature of the medium by means of the second probe element.

The invention will be explained further with reference to the figures, which are not true-to-scale, wherein the same reference signs designate the same features. For reasons of clarity, or if it appears sensible for other reasons, previously-noted reference signs will not be repeated in the following figures, in which:

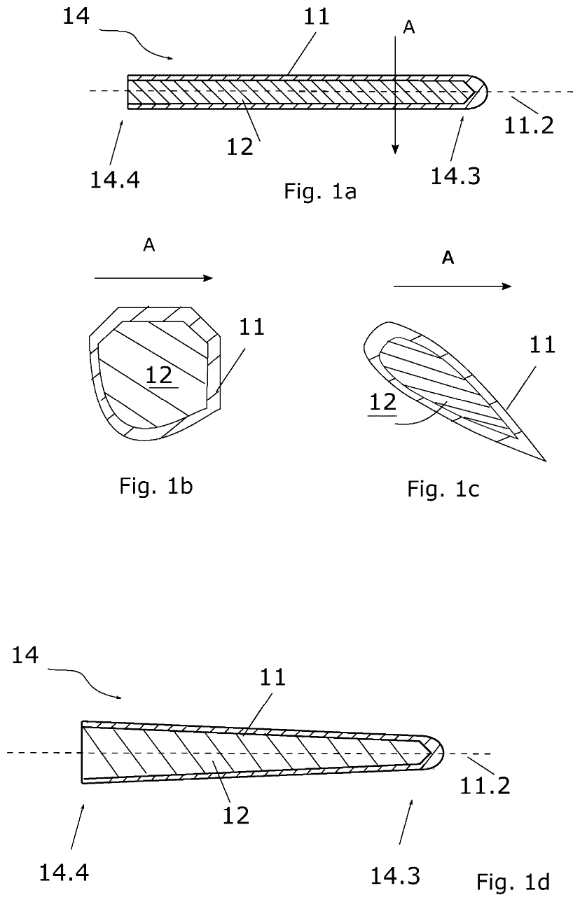

FIG. 1a is a sectional view of an embodiment of a probe body 14 of a probe element 10 according to the invention;

FIG. 1b, c show cross-sectional areas along a direction A perpendicular to the longitudinal axis 11.2, in different embodiments of a probe body 14 of a probe element 10 according to the invention;

FIG. 1d is a sectional view of a further embodiment of a probe body 14 of a probe element 10 according to the invention;

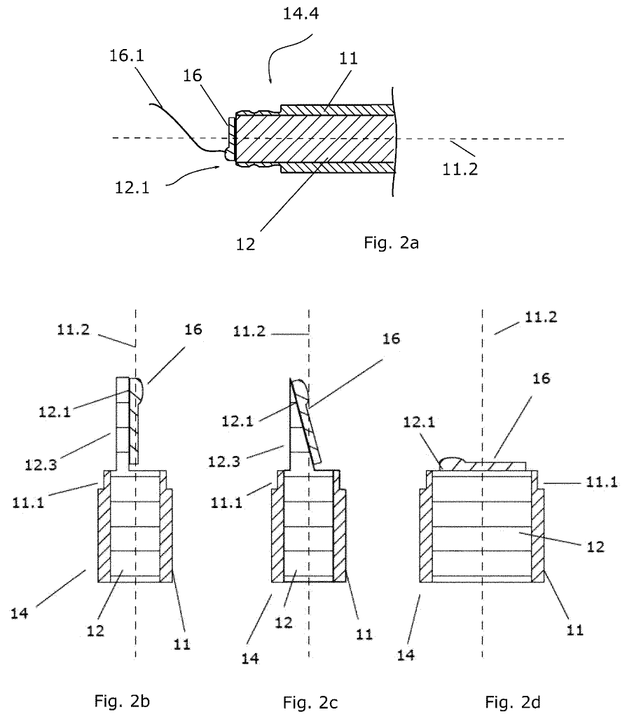

FIG. 2a-d are sectional views of a detail of a connection region 14.4 of a probe body 14 according to the invention with a sensor element 16 on the connection face 12.1 in the connection region 14.4, in an embodiment of a probe element 10 according to the invention;

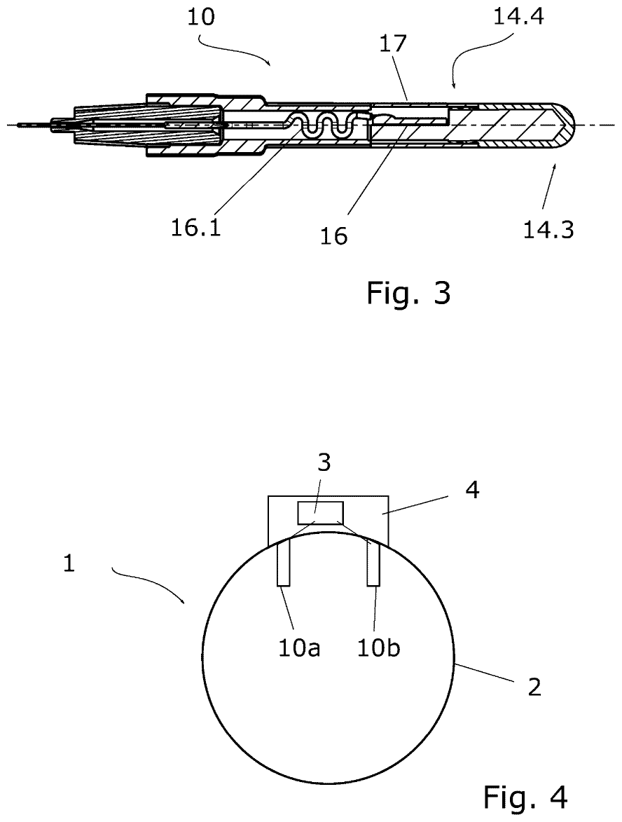

FIG. 3 is a sectional view of an embodiment of a probe element 10 according to the invention; and

FIG. 4 shows an embodiment of a thermal flowmeter having two probe elements 10a, 10b according to the invention.

FIG. 1a) shows a cross section of the elongate probe body 14 along its longitudinal axis 11.2, the probe body being produced by means of the generative manufacturing process. The probe body 14 is built up layer by layer additively, for example, by means of selective laser melting, electron beam melting, selective laser sintering, with an interior probe core 12 which is surrounded by the exterior probe sleeve 11. Preferably, 31 in the process according to the invention for producing the probe body 14, the probe core 12 and the probe sleeve 11 are built up layer by layer at the same time and the integral connection is produced directly in the generative production process. This optimizes the heat transfer mentioned above. The generative production process for producing the probe element is clear, for example, from the layers of the probe body 14.

For example, as shown here, the probe body 14 has, at a closure 14.3 which is to face the medium, a rounded shape such as a hemispherical or hemiellipsoidal shape, which is advantageous for flow resistance of the probe body 14. The exact shape of the closure 14.3 can preferably be freely designed within the framework of the generative manufacturing process and optimized for the particular application by a person skilled in the art.

After the production of the probe body 14 in the generative manufacturing process, a surface thereof, in particular of the exterior probe sleeve 11, is machined. For example, the entire lateral surface of the probe sleeve 11 is machined to achieve a sufficiently small average roughness Ra. The average roughness Ra is less than 3.2 μm, in particular less than 0.8 μm. Preferably, an average roughness Ra is less than 0.3 μm, and a person skilled in the art optimizes (with respect to flow) the probe body 14 or the average roughness Ra of its surface for the particular application.

In the context of this application, the “cross-sectional area perpendicular to the longitudinal axis 11.2” refers to a cross-sectional area with an area normal, the area normal being parallel to the longitudinal axis 11.2.

In the simplest case, the probe body 14 is cylindrical, in particular with a round or elliptical cross-sectional area of the probe body 14 along a direction perpendicular to the longitudinal axis 11.2, in which cross-sectional area the auxiliary arrow A shown in FIG. 1a lies.

FIGS. 1b) and 1c) show possible alternatives for cross-sectional areas that exploit the design freedom of the generative manufacturing process. They show a plan view of the cross-sectional area of the probe body, so that the auxiliary arrow A shown is rotated by 90°, in comparison with the view in FIG. 1a).

FIG. 1b) shows an at least partially angular and at least partially round cross-sectional area. With an at least partially angular cross-sectional area, separation edges are provided. FIG. 1c) shows another shape of the cross-sectional area, in the case of which a streamlined shape (also: droplet shape) is chosen. Depending on the direction of incident flow and/or the application, the design of the shape of the cross-sectional area according to FIG. 1b) or FIG. 1c) may be preferred.

FIG. 1d) shows a further possibility for designing the shape of the probe body 14, with the cross-sectional area decreasing from the connection region 14.4 towards the closure 14.3.

The probe body 14 typically has, regardless of the embodiment shown here, a length in the direction of the longitudinal axis 11.2 of 1 to 3 cm.

As already mentioned above, the probe sleeve 11 is thin in comparison with the probe core 12 and thus forms a wall for the probe body 14. This is because, for example, the probe sleeve 11 has a wall thickness of less than 0.5 mm, in particular less than 0.1 mm, and the probe core 12 has at least a wall thickness of 1.5 mm.

Regardless of the particular embodiment, the probe core 12 occupies a large part of the cross-sectional area in a probe core portion. The latter extends, in the direction of the longitudinal axis 11.2, from the connection face 12.1—see FIG. 2a)-d)—in the connection region 14.4 to the end of the probe core 12 adjacent to the closure 14. The probe core 12 constitutes at least 60%, for example 2/3, preferably at least 80%, of the cross-sectional area, in this aforementioned probe core portion.

The wall of the probe sleeve 11 forms a media-tight sealing surface for the probe body 14. The probe sleeve 11 surrounds the probe core 12 almost completely, except for an (exposed) connection face 12.1 (see FIG. 2a-d) of the probe core 12 in a connection region 14.4.

At the connection face 12.1, the probe core 12 is, for example, directly produced as exposed in the generative manufacturing process. Alternatively, the probe core 12 is first exposed by means of mechanical processing, in particular machining, of the connection face 12.1, namely after the generative manufacturing process.

In any case, at the connection face 12.1 the probe core 12 is exposed at least in parts such that, at the connection face 12.1, a sensor element 16 subsequently applied thereto can be thermally coupled to the probe core 12. This is presented in more detail in FIG. 2a)-d) explained below.

FIG. 2a) shows a detail of the connection region 14.4 of the probe body 14. A sensor element 16 is placed flatly onto the connection face 12.1. The sensor element 16 is fastened to the connection face 12.1, for example by soldering, gluing or sintering. In this embodiment, the connection face 12.1 is perpendicular to the longitudinal axis 11.2, further arrangements are shown in Fig. b)-d). The connection face 12.1 is formed by an end face of the probe core 12, so that the sensor element 16 is directly thermally coupled to the probe core 12. The sensor element 16 has a plurality of electrical connecting lines 16.1, by means of which the sensor element 16 can be connected to an electronic measuring/operating circuit 3 (see FIG. 4), for example for the operation of the sensor element 16 in a two-, three-, four-wire, etc. circuit by the electronic measuring/operating circuit 3.

The probe sleeve 11 has a tapered portion 11.1 adjacent to the connection face 12.1, for connecting the probe sleeve 11 to the connection sleeve 17. The connection sleeve is pushed onto the tapered portion 11.1 (see FIG. 3 shown below). The tapered portion 11.1 of the probe sleeve 11 is obtained directly in the generative process and/or created by subsequent processing, e.g., machining.

FIG. 2 b) to d) show cross sections through exemplary probe bodies 14 according to the invention with a probe core 12 and a probe sleeve 11. FIG. 2b) and c) each show a projection 12.3 with a connection face 12.1 from the probe core 12, in an exposed region in the connection region 14.4. Similarly to the tapered portion 11.1 of the probe sleeve 11, the projection is produced by processing, and/or created directly as part of the generative manufacturing process. The sensor element 16 is mounted on the connection face 12.1. In FIG. 2 d), a diameter of the probe body is large enough for placing the sensor element 16 flatly on a connection face 12.1 which is perpendicular to the longitudinal axis 11.2 of the probe body 14. The exemplary embodiments shown in FIG. 2 b) and c) allow probe elements 10 to be manufactured with a small diameter. For such an arrangement in FIG. 2b) and c), in one embodiment of the probe element 10 the angle of the connection face 12.1 to the longitudinal axis 11.2 is less than 30 degrees, and in particular less than 20 degrees, preferably less than 10 degrees. In this way, a thermal mass of the probe elements 10 and thus response behavior can be optimized.

FIG. 3 shows a final stage of the production of a probe element 10 according to the invention, wherein, after the sensor element 16 has been attached to the connection face 12.1, a connection sleeve 17 is pushed over the probe body 14 in the connection region 14.4, in particular over the taper 11.1 shown in the detail views in FIG. 2a-d. In particular, the connection sleeve 17 is pushed over the probe body 14 such that an exposed region of the probe core 12 is completely accommodated inside the connection sleeve 17. After the connection sleeve 17 has been fastened, for example by welding, in particular by means of a peripheral laser weld, the connection sleeve 17 and the probe sleeve 11 are in media-tight connection with one another and the probe core 12 and the sensor element 16 are located completely inside the probe sleeve 11 and the connection sleeve 17.

The probe sleeve 11 shown in FIG. 1a) to d), FIG. 2a) to d) and FIG. 3 is made of a first material comprising a stainless steel and/or nickel steel, and the probe core 12 is made of a second material, for example comprising silver or copper, the second material having a thermal conductivity of at least 100 W/(m*K), and in particular at least 200 W/(m*K) and preferably at least 300 W/(m*K). The connection sleeve 17 is in particular also made of the first material.

Since stainless steel or nickel steel has a lower thermal conductivity than the second material, a temperature change of the probe sleeve 11, which was caused, for example, by a change in the temperature of the medium, leads to a uniform or almost constant temperature distribution in the probe core 12, and thus for the probe element 10 according to the invention.

FIG. 4 shows a schematic front view of an exemplary thermal flowmeter 1 having a measuring tube 2 and two probe elements 10a, 10b according to the invention, which are arranged in the lumen of the measuring tube 2, and a housing 4, which housing 4 has an electronic measuring/operating circuit 3. The electronic measuring/operating circuit 3 is configured to operate the probe elements 10a, 10b and to provide flow measurement values. In order to measure the mass flow rate of a flowable medium through the measuring tube 2, for example a first probe element 10a in the medium flowing through the measuring tube 40 is heated such that a temperature difference with respect to the temperature of the medium remains constant. A second probe element 10b can be used to measure the temperature of the medium. Assuming consistent properties of the medium, such as density or composition, it is possible to determine the mass flow rate of the medium via the heating current necessary for maintaining the temperature. The thermal flowmeter 1 presented here is an example; a person skilled in the art will combine a number of probe elements 10; 10a; 10b as required and arrange them in the measuring tube 2 in a desired manner. Processes for operating such probe elements 10, 10a, 10b are prior art.

### REFERENCE SIGNS AND SYMBOLS

1 Thermal flowmeter
2 Measuring tube
3 Electronic measuring/operating circuit
4 Housing
10,10a,10b Probe elements
11 Probe sleeve
11.1 Taper
11.2 Longitudinal axis
12 Probe core
12.1 Connection face
12.3 Projection
14 Probe body
14.3 Closure of the probe body
14.4 Connection region
16, 16a, 16b Sensor elements
16.1 Connector
17 Connection sleeve

1-23. (canceled)

24. A method for producing a probe element for a temperature sensor for measuring a temperature of a medium or for a thermal flowmeter for measuring a mass flow rate of the medium in a measuring tube, the probe element operable for insertion into the medium, the process comprising:
fabricating an elongate probe body with a generative manufacturing process by a 3D printing process using at least two different materials,
wherein the probe body has a longitudinal axis and includes an exterior probe sleeve and an interior probe core disposed in the probe sleeve, wherein the probe sleeve at least partially spatially surrounds the probe core, and
wherein the probe core and the probe sleeve are integrally connected to each other in the generative manufacturing process.

25. The method according to claim 24, wherein the probe body is fabricated in the generative manufacturing process such that the probe body includes a closure adapted to face the medium, at which closure the probe body is sealed media-tight.

26. The method according to claim 24, further comprising:
after fabricating with the generative manufacturing process, mechanically processing a surface of the probe sleeve such that the surface has an average roughness of less than 3.2 μm after the probe body has been provided by the generative manufacturing process.

27. The method according to claim 26, wherein the average roughness of less than 0.8 μm.

28. The method according to claim 26, further comprising:
mechanically processing a connection face in a connection region of the probe body, which connection region is opposite from the closure with respect to the longitudinal axis of the probe body;
placing at least one sensor element on the connection face such that the at least one sensor element is thermally coupled to the probe core; and
fitting a connection sleeve onto the probe body adjacent the connection face such that the at least one sensor element is covered by the connection sleeve.

29. The method according to claim 28, wherein the at least one sensor element is connected to the connection face, and wherein the at least one sensor element is soldered or sintered onto the connection face, wherein the connection face is machined.

30. The method according to claim 28, wherein, when the connection sleeve is fitted onto the probe body, a media-tight connection is established between the connection sleeve and the probe body by welding the connection sleeve to the probe body.

31. The method according to claim 24, wherein the probe sleeve is made of a first material, and wherein the probe core is made of a second material, and wherein the first material has a lower thermal conductivity than the second material.

32. The method according to claim 24, wherein the probe core and the probe sleeve are built layer by layer during the generative manufacturing process, the layers having a layer thickness of 10-500 μm (micrometers).

33. The method according to claim 24, wherein the generative manufacturing process is an additive manufacturing process in which one of the following additive manufacturing processes is used: selective laser melting, electron beam melting, and selective laser sintering.

34. The method according to claim 26, wherein mechanical process is a machining operation.

35. A probe element for a temperature sensor for measuring a temperature of a medium or for a thermal flowmeter for measuring a mass flow rate of the medium in a measuring tube, the probe element obtainable by the method of claim 24, the probe element comprising:
an elongate probe body produced by a generative manufacturing process and having a longitudinal axis, the probe body including an exterior probe sleeve and an interior probe core located in the probe sleeve,
wherein the probe sleeve at least partially spatially surrounds the probe core, and
wherein the probe core and the probe sleeve are integrally connected to each one by the generative manufacturing process.

36. The probe element according to claim 35, further comprising:
at least one sensor element disposed on a connection face in a connection region of the probe body, which connection region is opposite from a closure adapted to face the medium with respect to the longitudinal axis of the probe body, the at least one sensor element thermally coupled to the probe core; and
a connection sleeve fitted onto the probe body adjacent the connection face such that the connection sleeve covers the at least one sensor element,
wherein the connection sleeve and the probe body are connected to each one in a media-tight manner.

37. The probe element according to claim 36, wherein the at least one sensor element is one of: a temperature sensor element; a heating element; and a sensor element adapted both for measuring temperature and for heating.

38. The probe element according to claim 35, wherein the probe sleeve includes a first material, and the probe core includes a second material, wherein the first material has a lower thermal conductivity than the second material.

39. The probe element according to claim 38, wherein the second material has a thermal conductivity of at least 100 W/(m*K).

40. The probe element according to claim 38, wherein the first material is stainless steel and/or nickel steel, and/or
wherein the second material is one of: silver, copper, and an alloy comprising silver and/or copper.

41. The probe element according to claim 40, wherein the second material is an alloy comprising silver and/or copper in a proportion of at least 60 percent by weight.

42. The probe element according to claim 35, wherein the probe body has a substantially cylindrical shape and a round or elliptical cross-sectional area perpendicularly to the longitudinal axis.

43. The probe element according to claim 35, wherein the probe body has a streamlined and/or angular cross-sectional area perpendicularly to the longitudinal axis.

44. The probe element according to claim 36, wherein the probe body has, perpendicularly to the longitudinal axis, a cross-sectional area that changes along the longitudinal axis, tapering from the connection region towards the closure.

45. The probe element according to claim 35, wherein the probe core has a minimum diameter of at least 1.5 mm and/or wherein the probe sleeve has a maximum diameter of at most 5 mm.

46. The probe element according to claim 35, wherein the probe sleeve forms a wall of the probe body with a wall thickness of less than 0.5 mm.

47. The probe element according to claim 36, wherein, in each cross-sectional area of the probe body perpendicular to the longitudinal axis, the probe core constitutes at least 60% of the cross-sectional area in a probe core portion that extends, in the direction of the longitudinal axis, from the connection face to an end of the probe core adjacent to the closure.

48. The probe element according to claim 36, wherein, in each cross-sectional area of the probe body perpendicular to the longitudinal axis, the probe core constitutes at least 90% of the cross-sectional area in a probe core portion that extends, in the direction of the longitudinal axis, from the connection face to an end of the probe core adjacent to the closure.

49. A thermal flowmeter, comprising:
a measuring tube for guiding a flowable medium;
at least one probe element according to claim 35, the probe element disposed in the measuring tube;
an electronic measuring/operating circuit configured to operate the at least one probe element and to generate flow measurement values; and
a housing adapted to house the electronic measuring/operating circuit.

50. The thermal flowmeter according to claim 49, wherein the at least one probe element includes:
a first probe element including at least one sensor element adapted for heating; and
a second probe element including at least one sensor element adapted for measuring the temperature,
wherein the electronic measuring/operating circuit is configured to heat the first probe element and to determine the temperature of the medium using the second probe element.
